(19) United States
(12) Patent Application Publication
(10) Pub. No.: US 2025/0374914 A1
(43) Pub. Date: Dec. 11, 2025

(54) Eave Dropper

(71) Applicant: Robert William Suchecki, Woodbury, CT (US)

(72) Inventor: Robert William Suchecki, Woodbury, CT (US)

(21) Appl. No.: 19/211,798

(22) Filed: May 19, 2025

Related U.S. Application Data
(60) Provisional application No. 63/655,535, filed on Jun. 3, 2024.

(51) Int. Cl. A01M 29/08

(52) U.S. Cl. CPC A01M 29/08; A01M 2200/00

(57) ABSTRACT

The disclosed design is a lightweight, non-slip product for keeping pests away from structures, that can be thrown from the ground onto the roofline of any structure, and then easily moved and/or retrieved.

### BACKGROUND

Wood fascia and structural boards comprising the eaves and decking around dwellings are frequently destroyed by pests such as woodpeckers. The damage can be extreme and the cost of repairs prohibitive. Fake sculptures of predators, higher-tech devices employing audio recordings, lasers, and reflective objects are available options for deterring these pests. All of the available products need to be permanently installed. The property owner would need to get on a 20+ foot ladder with power tools in hand for installation. Many property owners cannot afford a roofing expert to install these items and have no business being on a 20+ foot ladder for do-it-yourself installation.

The disclosed design provides a device that deters pests and can be installed by a property owner without any risk of falling from a ladder.

### SUMMARY

This disclose provides information related to a lightweight, non-slip product that can be thrown from the ground onto the roofline of any structure, and then easily moved and/or retrieved.

In an embodiment, the device is composed of parts that include an anchoring container, a retrieval cord, and a reflector.

In an embodiment, a method for controlling property damage caused by wildlife is achieved by attaching an anchoring container to a reflector and a retrieval cord to have an assembled device that can be thrown from a safe position to the area of the property that needs deterrence.

In an embodiment the device is secured in place using a retrieval cord.

### BRIEF DESCRIPTION OF DRAWINGS

FIG. 1—Shows a top view fully assembled representation of the device for pest deterrence.

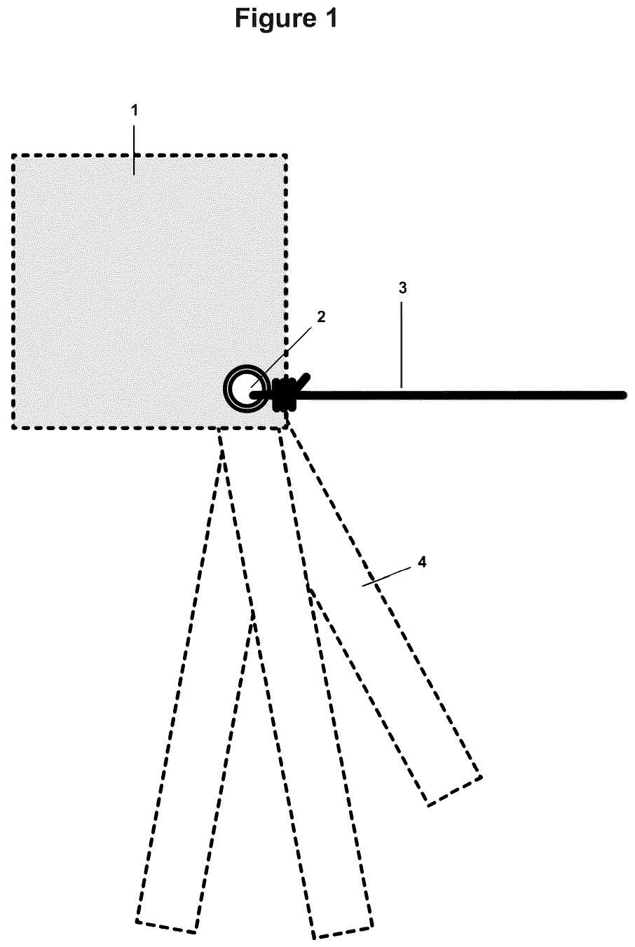

FIG. 2—Shows a bottom view representation of the individual parts of the device for pest deterrence.

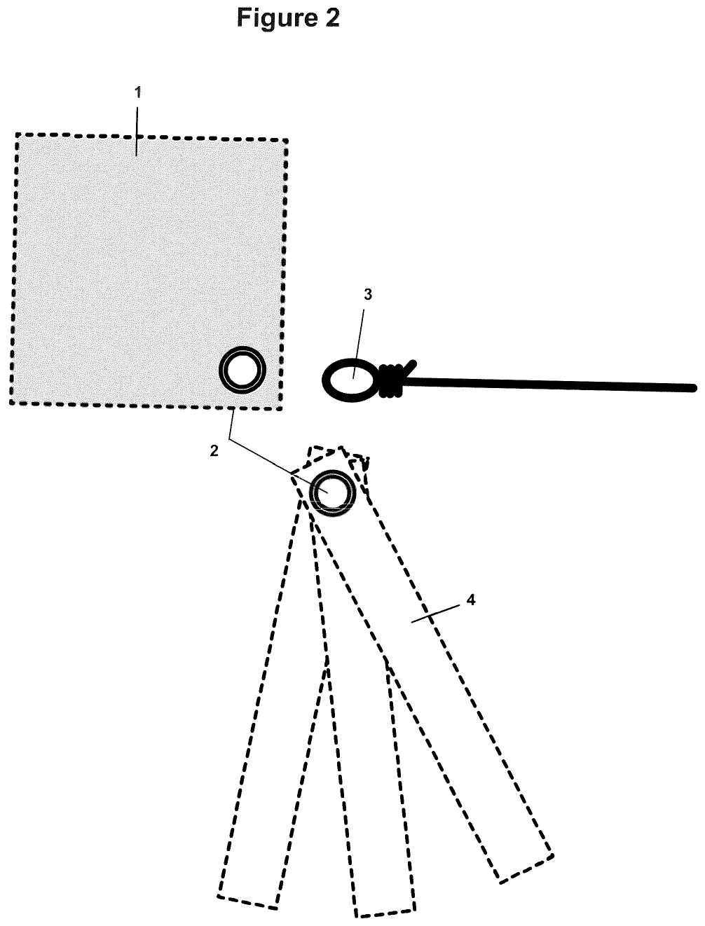

FIG. 3—Shows a side view representation of the fully assembled device for pest deterrence.

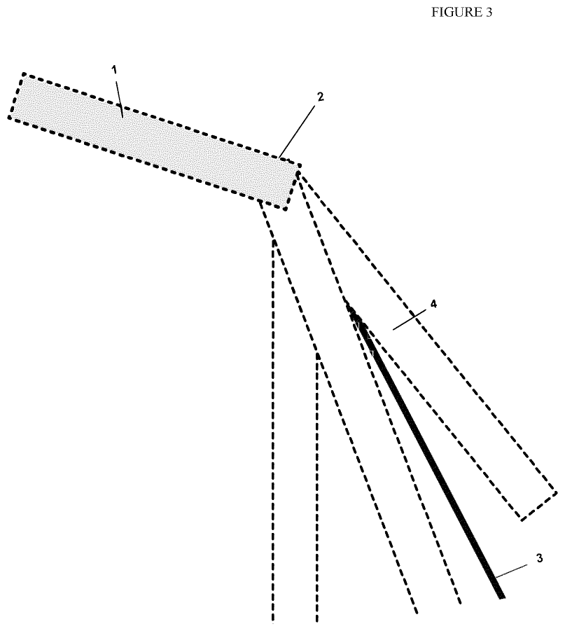

FIG. 4—Shows the device in place on a roof.

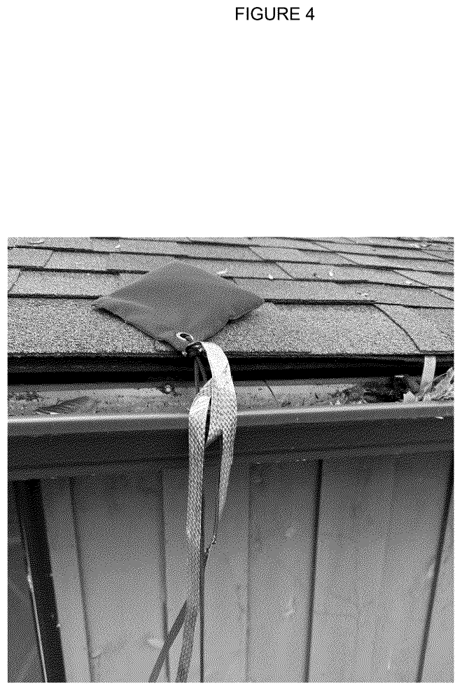

### DETAILED DESCRIPTION OF THE INVENTION

The terms used in this specification generally have their ordinary meanings in the art, within the context of the invention, and in the specific context where each term is used. Certain terms are discussed below, or elsewhere in the specification, to provide additional guidance to the practitioner in describing the compounds, compositions, and methods and how to make and use them. Moreover, it will be appreciated that the same thing can be said in more than one way. Consequently, alternative language and synonyms may be used for any one or more of the terms discussed herein, nor is any special significance to be placed upon whether or not a term is elaborated or discussed herein. The use of examples anywhere in this specification, including examples of any terms discussed herein, is illustrative only, and in no way limits the scope and meaning of any exemplified term. Likewise, the examples presented are considered non-limiting.

As used herein one embodiment,” “an embodiment,” “an aspect,” “one aspect,” indicate inclusion of a particular feature, structure, or characteristic. This is not an inclusion of all possible features, structures, or characteristics. Moreover, such phrases are not necessarily referring to the same aspect or embodiment. Further, when a particular feature, structure, or characteristic is described in connection with an aspect or embodiment, it is submitted that it is within the knowledge of one skilled in the art to effect such feature, structure, or characteristic in connection with other aspects or embodiments whether or not explicitly described. Additionally, it should be appreciated that items included in a list in the form of “at least one 1, 2, and 3” can mean (1); (2); (3); (1 and 2); (1 and 3); (2 and 3); or (1, 2, and 3). Similarly, items listed in the form of “at least one of 1, 2, or 3” can mean (1); (2); (3); (1 and 2); (1 and 3); (2 and 3); or (1, 2, and 3).

As used herein, “about” or “approximately” shall generally mean within 20 percent, preferably within 10 percent, and more preferably within 5 percent of a given value or range. Other than in the operating examples, or where otherwise indicated, all numbers expressing quantities of ingredients and/or reaction conditions are to be understood as being modified in all instances by the term “about”.

As used in the specification and the appended claims, the singular forms “a,” “an,” and “the” include plural referents unless the context clearly dictates otherwise.

As used in this specification and the appended claims, the term “or” is generally employed in its sense including “and/or” unless the context clearly indicates otherwise.

While the concepts of the present disclosure are susceptible to various modifications and alternative forms, specific aspects and embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims. It will be apparent to one skilled in the art that various changes or equivalents may be made without departing from the scope herein.

Wildlife can take many forms, as used herein wildlife is any mammal, bird or insect that can alone or in a group can destroy a natural or manufactured planting or structure. Examples of wildlife include a bird, a boring insect, or a mammal with teeth or antlers. Some non-limiting examples include woodpeckers, deer, carpenter bees, and beavers.

The device described herein was designed to control property damage caused by an at least one of the wildlife described. Property damage caused by wildlife most frequently happens to property made of wood. The wood can be a composite of wood or a natural wood product. The wood can be treated or untreated. By way of example the wood can be painted, resin coated, unpainted, stained, or natural. Some non-limiting examples include a tree branch or trunk, a deck, a fence, a soffit, a gutter, a roof, a support beam, a pier, or a pile.

Property damage can take the form of holes in the property or severance of parts of the property so it no longer can serve the intended function.

The device for controlling property damage described herein in the simplest form has three parts; an anchoring container (1), a retrieval cord (3), and a reflector (1). Additional parts could be added to the device described, however, additions that still perform the function of controlling property damage caused by wildlife would be obvious and anticipated by this claimed device.

The anchoring container (1) shown in the drawings is in the shape of a square. This is a non-limiting example, and the anchoring container can be of any geometric shape that allows the device to be tossed to a desired area in the property and be stationary.

The anchoring container (1) has a means for securing (4) the retrieval cord (3) and reflector (3). The means of securing can take the form of for example, a gromet, a staple, or a hole.

The anchoring container (1) requires to be a color that deters wildlife from approaching the container. By, way of example, a shade of red will deter a woodpecker.

The anchoring container (1) needs to be stationary when located in the area of the property where damage can occur. This can be achieved by making the anchoring container (1) of a non-slip material or a weighted material.

The retrieval cord (3) is used to remove the device from the current location. The retrieval cord is made of a material that can withstand all weather conditions. The retrieval cord is of sufficient length to be secured in place and easily retrieved from the secure location.

The reflector is made of a material that moves freely with air currents or wind. The reflector is an at least one piece of material.

The device for controlling property damage can be held by a human and tossed or placed by a human in a location to prevent property damage.

What is claimed:

1. A device for controlling property damage caused by an at least one wildlife, comprising:
a) an anchoring container;
b) a retrieval cord; and
c) a reflector.

2. The device of claim 1, wherein the anchoring container is composed of a non-slip material.

3. The device of claim 2, wherein the anchoring container is weighted.

4. The device of claim 2, wherein the anchoring container is comprised of a color that deters a wildlife from approaching the container.

5. The device of claim 4, wherein the color is a shade of red.

6. The wildlife of claim 4, wherein the wildlife is a bird.

7. The wildlife of claim 6, wherein the bird is a woodpecker.

8. The device of claim 1, wherein the property is wood.

9. The device of claim 8, wherein the wood is a tree branch, a deck, a fence, a soffit, a gutter, or a roof.

10. A method for controlling property damage caused by wildlife comprising:
a) attaching an anchoring container to a reflector and a retrieval cord;
b) from a safe position throw the anchoring container on the area of the property that needs protection from wildlife; and
c) secure the retrieval cord.

11. The device of claim 10, wherein the anchoring container is composed of a non-slip material.

12. The device of claim 11, wherein the anchoring container is weighted.

13. The device of claim 11, wherein the anchoring container is comprised of a color that deters a wildlife from approaching the container.

14. The device of claim 13, wherein the color is a shade of red.

15. The wildlife of claim 13, wherein the wildlife is a bird.

16. The wildlife of claim 15, wherein the bird is a woodpecker.

17. The method of claim 10, wherein the safe position is a wood surface, a grass surface, a concrete surface, a gravel surface, a ladder rung, and a metal surface.

18. The wildlife of claim 10 wherein the wildlife is a bird.

19. The wildlife of claim 18, wherein the bird is a woodpecker.

20. The device of claim 10, wherein the property is wood.
